(19) United States
(12) Patent Application Publication
(10) Pub. No.: US 2011/0036151 A1
(43) Pub. Date: Feb. 17, 2011

(54) Instrumentation of Acoustic Wave Devices

(75) Inventors: Jeffrey C. Andle, Falmouth, ME (US); Daniel S. Stevens, Stratham, NH (US); Reichl B. Haskell, Nashua, NH (US)

Correspondence Address: SALTAMAR INNOVATIONS, 1 Mathewson Road, Barrington, RI, 02806, US

(73) Assignee: DELAWARE CAPITAL FORMATION, INC., Wilmington, DE (US)

(21) Appl. No.: 12/540,339

(22) Filed: Aug. 12, 2009

(51) Int. Cl. G01N 11/16

(52) U.S. Cl. 73/54.41

(57) ABSTRACT

Characterizing material properties using a simple and inexpensive measurement circuit is disclosed. It allows measurement of the transfer function change of an acoustic wave device without necessitating detailed knowledge of the resonant frequency, by integrating the transfer function. If one examines the integral of the transfer efficiency of an acoustic wave device as the acoustic wave is damped, one sees that the magnitude of the total signal transfer decreases with increasing damping allowing derivation of the material parameters from the results of simple integration.

### FIELD OF THE INVENTION

This application is directed generally to acoustic wave devices, and more particularly to methods, systems and devices for measuring data relating to their operating parameters in a specific environment, such as when such devices are used as sensors responding by a change in transmission efficiency to an environmental stimulus.

### BACKGROUND OF THE INVENTION

A resonant acoustic wave device is considered herein a device comprising a crystalline material having a plurality of electrodes, and that in response to electrical power presented between at least a pair of these electrodes, provides a corresponding movement of the crystal face, and conversely, generates an electrical signal in the electrodes in response to power applied to the crystal face. Resonant acoustic wave devices support at least one resonant structure for interconverting electrical and acoustical signals at or about at least one resonant frequency. In the case of a transversal filter or delay line, the resonant structure is the interdigital transducer (IDT) and the resonant frequency is the synchronous frequency of the IDT with a bandwidth on the order of the inverse of the length. Typically a resonant acoustic wave device is considered to have multiple internal reflections or electrical regeneration. In these specifications the terms AWD and acoustic wave device or resonant acoustic wave device shall be used interchangeably, unless otherwise clear by context.

Acoustic wave devices have been used extensively in the art as frequency reference resonators, delay lines, and sensors. Different styles and designs of AWD are known, generally classified by the manner in which they operate and how waves propagate therethrough. By way of non-limiting example, such classifications include surface acoustic wave (SAW) devices, bulk acoustic wave (BAW) devices, and different variations such as thickness shear mode (TSM), leaky SAW, shear-horizontal SAW (SH-SAW), shear horizontal acoustic plate mode (SHAPM), and the like. Monolithic crystal filter (MCF) structures and other coupled-resonator structures may particularly benefit from certain aspects of the present invention.

When AWDs are used as sensors, at least one surface of a piezoelectric/ferroelectric material is brought into contact with a viscoelastic material for measuring at least some of the characteristics of the viscoelastic material. The acoustic wave propagates through, or on the surface of, the piezoelectric/ferroelectric material and environmental changes—at least some of which come from the viscoelastic material—effect the propagation by changing the velocity and/or amplitude of the wave. Changes in velocity or amplitude will result changes in the characteristics of the AWD, and can then be correlated to a corresponding physical quantity that caused the change.

Obtaining information about the environment in which the AWD operates makes the AWD into a sensor. However, the sensor needs to be coupled to equipment—circuitry, computing device, and the like—so as to provide useful information. This connection method, support circuitry, and manners of decoding the information, are colloquially known as the ‘instrumentation’ of a device and providing said instrumentation is known as ‘instrumenting’ the device.

FIG. 1 depicts a common way of instrumenting an AWD sensor (power connections are omitted for simplicity). AWD 100 is coupled to amplifier 110, which acts as a feedback amplifier. The circuit forms an oscillator whose frequency is typically controlled by a resonant frequency or passband frequency of the AWD such that the loop phase and loop gain meet the conditions of positive feedback with greater than unity open loop gain at said oscillation frequency. This method was initially developed to track the frequency response, itself, as in a quartz crystal microbalance (QCM), in which case a frequency counter would be employed (not shown). Frequency information alone is inadequate in many applications and in others the time-base frequency stability required in the instrumentation in order to properly measure small changes in AWD frequency results in prohibitively expensive instrumentation.

Many variants of the basic oscillator were developed, directed at monitoring the dissipation losses or the transmission insertion losses. In FIG. 1, power metering circuitry 120 and 130 are coupled to the input and output of the AWD. The comparator circuit 140 compares the input and the output signal levels, generating a physical indication which may be correlated to the measured characteristic of the sensor-environment interaction. Note that signal ratios are explicitly contemplated since the detectors may be logarithmic. Alternately, linear detectors may be employed and the comparator may be replaced with a ratiometric circuit such as a ratiometric analog to digital converter (ADC).

These approaches benefit from the inherent tracking of the resonator peak by a well-designed oscillator, since the phase and gain conditions needed to sustain oscillation are reasonably correlated. However, the oscillator instrumentation suffers limitations due to the finite dynamic range of the feedback circuits with respect to variations in attenuation through the AWD. The AWD oscillations are oftentimes damped by the environmental interaction (notably when loaded with a viscous liquid) to a level that prevents oscillations, and acceptable signal to noise (S/N) ratio are hard to maintain. At the other extreme, a circuit designed to tolerate large amounts of damping will be excessively saturated under light damping. Saturation changes the impedance characteristics of the instrumentation and alters the behavior of the AWD. Therefore, the dynamic range and linearity of the measurement is limited. Furthermore, the oscillation frequency will change with many conditions, such as temperature, pressure, strain, damping, and the like. Therefore, the input impedance of the circuit will also change with varying conditions. Due to all of the above-mentioned limitations, oscillator based methods of instrumentation suffer limited dynamic range and linearity, and are prone to complex, compound measurement error. This often results in lengthy calibration processes and, in extreme cases, excessive drift of the sensor.

Damping of the signal in the AWD (attenuation) is often modeled as a motional resistance as shown in FIG. 2. It would simplify instrumentation if changes in the electrical measurand directly reflected the associated motional resistance of the AWD's equivalent circuit model or a related parameter. However, present methods typically do not provide an easy and simple way of obtaining motional resistance from oscillators over wide changes in damping other than through sensor-specific calibration and/or numerical curve-fitting. For the oscillator system these are limited by the changing impedance of the circuit, by which any estimate of the AWD motional resistance is normalized.

Transmission measurements of electrical networks, including crystal resonators, are known and share one of two basic underlying architectures and principles of operation.

In the first and most widespread architecture, an independently swept frequency signal is applied to a network input and the transmitted signal is measured at the network output. When applied to the measurement of an acoustic wave device (AWD) used as a sensor, the approach requires substantial post processing and peak detection algorithms. While computing power is increasingly available with continually less electrical power consumption and cost, such computing devices are still not capable of surviving the extreme conditions under which some sensors are operated. Furthermore, challenges exist in obtaining a sufficiently wide band source with sufficiently detailed frequency resolution and sufficiently low cost. Typically the cost and stability requirements dictate a voltage controlled crystal oscillator (VCXO) using another quartz resonator as a frequency reference or direct digital synthesis (DDS). The frequency range of the VCXO is typically too small to allow an adequate manufacturing tolerance of the sensor element. DDS options offer some promise but still require excessive computational overhead to track a moving target frequency. Even when such computational power is available, the errors associated with peak interpolation may exceed the tolerances of the application.

The bandwidth of many AWDs increases with damping. While this phenomenon would apparently assist in matching the frequency of the signal source with the resonant frequency of the AWD, it results in more variables that are either unknown or require complex computations. This further complicates instrumentation of the sensor and reduces accuracy.

An alternate architecture employs a voltage controlled oscillator (VCO) as a frequency modulated “continuous wave” (CW) oscillator, combined with a phase detector which monitors the transmission phase of the AWD. Thus the VCO is controlled by a phase locked loop (PLL) system to maintain the “CW” at the frequency of constant phase shift through the AWD. The VCO-PLL system has its own limitations with regards to tuning range and stability. In particular, it is difficult to obtain the desired sweep range and resolution required for sensor instrumentation while maintaining low-cost and providing highly temperature-stable operation. Other problems with the PLL system include sensitivity of the phase detection and lock circuitry to amplitude shifts and loss of stability as the phase slope with frequency diminishes under high damping conditions.

In the past, AWD sensors were traditionally seen as either changing their resonant frequency or their delay time in response to a measurand. Such sensors did not require accurate amplitude data and were able to use interpolation methods to obtain the requisite frequency or phase information, often with the instrumentation remote from the sensors. More recently a growing class of applications exists, in which the sensor electronics must be closely integrated to the sensor and jointly operated in harsh environments. By way of example, in-engine sensors for automotive applications can require −40° C. to +160° C. operating ranges with low electrical power budgets and stringent size and cost constraints. Many of these applications are served through AWD configurations in which the change in amplitude is responsive to the measurand. One such sensor is an oil viscosity sensor using a thickness shear mode (TSM) sensor, preferably one employing the monolithic crystal filter (MCF) topology.

FIG. 2 represents a common equivalent circuit to a two-port, multi-mode, resonant AWD having an input, an output, and a common (“ground”) connection with a plurality of series resonant circuits connecting the input and output. The shunt branches represent the electrostatic capacitance of the sensor element from input and output to ground. Multi-mode resonant devices may be modeled and/or represented with other circuit configurations and neither the example nor the representation of resonant as apposed to transversal structures, should be construed as limiting.

Each remaining series branch of the equivalent circuit 210, 220, 230 represents a specific resonance of the AWD at a series resonant frequency, Fₙ. In the two port case there also exists a phase shift that is typically about 0° or 180° depending on the relative polarity of the input and output electrodes for the corresponding resonance. The sequence of the phase shifts alternate with increasing resonant frequencies, in a manner determined by the causality constraints.

Traditionally an increase in mass adsorbed onto the sensor is modeled as an increase in the series motional inductance; a change in elastic stiffening of the surface is modeled as a change in motional capacitance; and a change in damping is modeled as a change in motional resistance. In order to improve clarity and brevity, these specifications will utilize primarily examples relating to fluids; however, the skilled in the art will recognize that the principles disclosed herein equally apply to rubbery polymers in the regime where the frequency-viscosity product is small compared to the intramolecular elasticity. This may be mathematically conveyed by examining the effective shear viscoelastic modulus, μ_{EFF}, of the viscoelastic material adjacent to the crystal, in terms of the parallel combination of modulus, μ, and viscosity η at the resonant frequency, ω=2πF,

μ_{EFF}=1/[1/μ+1/jωη]=jωημ/(μ+jωη)=jωη/(1+jωτ),

and requiring that the product of frequency, ω, and the characteristic time constant of the adjacent material, τ=η/μ, be sufficiently small to observe the viscous component. Rubbery polymers behave approximately as fluids whereas glassy polymers behave more like solids.

There exists a continuity of materials with Newtonian fluids at one extreme with τ=0 and with elastic solids at the other extreme with ωτ→∞. Between these are Maxwellian fluid with relatively small ωτ, rubbery polymers with ωτ<1, and glassy polymers with ωτ>1. The embodiments and methods referenced herein, including external references, while disclosed and exemplified using Newtonian fluids, are practicable with reasonable accuracy for non-ideal fluids and rubbery polymers. Viscoelastic materials encompass all materials in this continuum having sufficiently small ωτ to provide measurements of a desired accuracy in the methods disclosed herein. There exist numerous applications where reproducibility of measurements is critical but the absolute accuracy of the measurement is immaterial. Thus the applicability of various embodiments of the present invention is dependent on the desired accuracy and repeatability of the task at hand.

In a U.S. Pat. No. 7,007,546, issued Mar. 7, 2006 titled “Measurement, Compensation and Control of Equivalent Shear Rate in Acoustic Wave Sensors” (which is incorporated herein by reference in its entirety), Andle, a co-inventor of the present application, disclosed a method for measuring viscosity and shear rate at which the measurement is performed by utilizing an AWD as a sensor, and calculating the shear rate as a function of the characteristic rate of fluid movement in response to a given power transmitted to a fluid, and the viscosity of the fluid. The acoustic wave device has a characteristic relationship between input power, output power, and an acoustic wave amplitude at a selected region between the input and output transducer. The acoustic wave device is coupled to the measured fluid. A predetermined power level Pᵢₙ of a harmonic signal is applied to an input transducer, to impart an acoustic wave at the selected region. Output power level Pₒᵤₜ is measured at the output transducer. Using the characteristic relationship, and the input and output power levels, the amplitude of the average acoustic wave imparted to the fluid is calculated. Measuring the viscosity of the fluid to obtain a measured viscosity at the selected region, allows calculating of the shear rate of the fluid at the selected region, by using the frequency, the viscosity measurement, and the acoustic wave amplitude. This invention may be beneficially used with the present invention as explained below.

In PCT patent application No. PCT/US04/12546, and later in U.S. Pat. No. 7,552,619 (which are incorporated herein by reference in their entirety), titled “Measurements of Density and Viscoelasticity with a Single Acoustic Wave Sensor”, Andle described a two-port, two-pole coupled resonator with a textured entrapment layer in contact with a fluid to be measured, such as a liquid or a gas, which allows measurement of viscosity and density of the fluid. The structures and methods disclosed in U.S. Pat. No. 7,552,619 may be practiced in conjunction with the present invention. It is noted that the incorporation of a textured surface is not necessary to embody aspects of the present invention.

U.S. patent application Ser. No. 12/036,125 to Andle, (which is incorporated herein by reference in its entirety), titled “Sensor, system, and method, for measuring fluid properties using Multi-Mode Quasi-Shear-Horizontal Resonator”, discloses sensors and methods of measuring a plurality of fluid characteristics using a single sensor. That invention relies on the subtle differences in the interaction of two or more acoustic resonance states or waveguide modes of a multi-mode resonator or waveguide. It uses a multi-mode coupled resonator filter geometry, with one resonant mode having a high degree of symmetry and the other having a high degree of anti-symmetry. By combining the additional information of multi-moded operation with the inherent ability of a horizontally-polarized quasi-shear-horizontal acoustic wave device (AWD) to operate in fluid environments, one obtains a multi-mode quasi-shear-horizontal (MMQSH) resonator, which provides information on two of the three variables, density (ρ), viscosity (η), and elastic modulus (c), such that independent knowledge of one variable allows the remaining two variables to be measured by a single sensor. This is done by having a MMQSH resonator exposed to fluid damping on at least one face. The MMQSH resonator measuring surface has two active regions and a separation area defined therebetween. Feeding the MMQSH resonator with excitation energy at a first frequency which corresponds to a first mode causes the two active regions to move in phase and feeding the MMQSH resonator with a second frequency which correlates to another mode, causes the active regions to move out of phase relative to each other. The out of phase movement induces vertical displacement in the separation area. Using well known mathematical manipulations, examples of which are also detailed in the '125 application, allows measuring the parameters related to the supply and lost energy in the two modes allows computing two of the fluid parameters when a third is known. As will be seen below, the invention principles disclosed in U.S. Ser. No. 12/036,125 may be advantageously used with the present invention and, as discussed above, may be practiced with non-ideal fluids and rubbery polymers to a reasonable degree of accuracy.

Another method of measuring AWD sensors employs wireless interrogation using reflected parameters of a device or ensemble of devices. A radio frequency pulse is applied to an antenna, propagates to an antenna connected to the sensor and excites acoustic waves in the sensor. The sensor reflects acoustic waves internally and reradiates a portion of the incident energy.

In some such systems the AWD comprises a resonator with a well defined resonant frequency and the sensor measured variable is the output frequency. In other such systems the AWD comprises time-staggered reflectors with wideband reflection and the sequence of time delayed bits and variations in its amplitude and relative delay provides the sensor information.

In another group of such sensors, as described by Solie in U.S. Pat. No. 7,434,989 by way of example, there exists a plurality of single-reflection delay paths with time-overlapped reflections such that changes in delay time of one path, e.g. with temperature, relative to the other path cause changes in the coherence of the two reflections. At some frequencies the reflections will become more in phase and in other frequencies they will become less in phase. When interrogated with a very broadband signal, such as a short pulse, the response signals combine to produce a signal with a power spectral density such that the integrated power within each of two specified portions of the spectrum provides an indicator of the temperature. The Solie patent does not provide for measurement of fluid or polymer properties other than temperature, which is measured by equilibrating the SAW substrate temperature to that of the surrounding medium. Such sensors do not employ a resonant structure but instead employs a broadband, time domain interference structure to create a comb filter. Solie employs power spectral density, which should be differentiated from a transfer function, as the apparatus has variable losses due to changes in path length as a wireless sensor, thus the input cannot be sufficiently well known to allow the integrator to approximate a transfer function.

The instrumentation of the sensors described above is often hampered by high cost, intensive computational requirements, or exposure to hostile environments. Therefore there is an increasing but as of yet unfulfilled need for simple and robust instrumentation of acoustic wave device (AWD) sensors that provides amplitude or attenuation based response to a measured fluid property.

### SUMMARY OF THE INVENTION

The present invention seeks to obtain a measure of the change in the motional resistance of one or more resonant modes of an AWD by relating the motional resistance of the mode to the integral of at least one transfer function of an acoustic wave device without necessitating detailed knowledge of the resonant frequency. If one examines the integral of the transfer efficiency of an acoustic wave device as the acoustic wave is damped, one sees that the magnitude of the total signal transfer decreases with increasing damping, despite the fact that the width of the resonance can increase dramatically with damping. The term transfer function represents the change between the input signal and output signal of an AWD. The parameters of a transfer function are the units of the input and output signal and may vary. Typical units of measure for the signal include power, voltage, amplitude, and current. The ratio of a selected output signal to a selected input signal defines transfer functions including voltage gain, current gain, power gain, transfer resistance, transfer impedance, transfer reactance, transfer conductance, transfer susceptance, transfer admittance (the above transfer functions like transfer resistance, impedance, reactance, and the like are often colloquially related to as trans-resistance, trans-impedance, trans-reactance, and the like, respectively.), the different representations of power flow (as in scattering parameters, RMS, and the like) or any other hybrid parameter where the input and output of the acoustic wave device are correlated. Clearly, for sensing application, at least one transfer function is selected, which is determined by the nature of the measurement circuitry and any desired mathematical transformations thereupon. The specific transfer function or functions selected for monitoring, is however a matter of technical choice.

In some cases the nature of the excitation (voltage source, current source, matched impedance source) may be independent of the predetermined transfer function if the input signal is measured. For example, a power source having characteristic impedance may be applied but the RMS voltage may be measured and employed in determining a voltage gain, a trans-admittance, or another ratio of output signal to input voltage.

Thus, in a simple embodiment of the invention there is provided an apparatus that comprises a signal source which provides a plurality of frequencies. The signal source may supply a voltage, current, or power signal. The frequencies may be applied simultaneously or they may be changed sequentially, or a combination thereof. Changing signal frequencies may either be continuously varied or stepped and may be stepped monotonically or in a pseudorandom “frequency hopping” pattern. The signal from the source is fed as input to an AWD which is exposed to environmental conditions that result in damping effects which are being measured. An example of such environmental conditions is the damping due to a fluid or polymer material in contact with at least a portion of the AWD based sensor surface. The output of the AWD over a range of frequencies is fed to an integrator, which is constructed to integrate the transfer function relating the input signal and the output of the AWD. wherein the integrated result reflects at least one measured characteristic of the interaction between the environment and the sensor. Most preferably the output of the AWD is taken with respect to the input to properly define the transfer function; however the input signal may be sufficiently well controlled to obviate this need. The signal source is commonly referred to as an input signal generator. In certain embodiments, as will be seen below, the signal generator comprises a noise source.

Ideally the signal transfer is approximately zero outside the resonance or filter passband, allowing the integral to be taken over a spectral range significantly wider than the resonator bandwidth. Taking the integral over a frequency range that is as close as possible to the resonance filter passband limits additive noise; however leaving sufficient frequency margin compensates for variations between individual AWD's and for thermal drift. However more noise is added to the integral as the frequency is swept over increasing bandwidth, increasing the error. Thus preferably the bandwidth is selected so as to limit the noise effects while overcoming the thermal drift and the part-to-part variation between AWD's.

Thus in one aspect of the invention there is provided a method of measuring material properties comprising the steps of providing a resonant acoustic wave device (AWD) having at least one face thereof in contact with the material, feeding the AWD an input signal at a plurality of different frequencies, obtaining an output signal from the AWD, and integrating the predetermined transfer function over at least a subset of the plurality of frequencies for deriving the material properties. The output signal and input signal determining the values of a preselected transfer function of AWD. The material may be any viscoelastic material.

In one embodiment, the input signal is of known value, and the output signal is directly correlated to the transfer function. In another embodiment, the transfer function represents the measured ratio between the input and output magnitude, and in a more preferred embodiment, the integration is performed on only the real part and/or the imaginary part of the ratio. Optionally the input signal is measured as an applied voltage, and the output signal is current output of the AWD when the AWD is short circuited, and the transfer function is the transfer conductance of the AWD

Optionally, the AWD has a plurality of acoustic modes, and a plurality of integrals are taken over selected subsections of the plurality of frequencies, where the subsections corresponding to at least a portion of said plurality of acoustic modes. Preferably, at least two of said plurality of integrals are used to derive information regarding a differing characteristics of the fluid or polymer. In one preferred embodiment, the differing characteristics consists at least two of viscosity, elastic modulus, and density of the fluid or polymer.

In one embodiment, the plurality of frequencies are fed to the AWD simultaneously, such as by feeding a noise signal known to cover the desired frequencies, or just by mixing the desired frequencies into a single signal and feeding it to the AWD.

In certain embodiments the noise signal is conveniently obtained from other circuit or system elements as a byproduct of their intended use. A system may already comprise a spread spectrum clock signal which has the required spectral content for excitation of the AWD. Alternately, the switching noise of digital circuitry may contain the relevant frequencies in a reproducible fashion. By these nonlimiting examples, the skilled in the art will recognize that a dedicated frequency-agile signal source is not necessary to practice the invention, and that varying sources of noise or input signals will be cleared in light of the teachings of the present invention.

In certain embodiments of the invention there is provided a method of measuring fluid or polymer properties as described above, wherein the AWD is a multi-mode quasi shear horizontal AWD, and wherein the plurality of frequencies comprise at least a first and a second frequencies selected to excite a first and a second acoustic modes respectively in the AWD. Each of said acoustic modes causing a component of horizontal shear wave motion in at least one surface of the AWD which is in contact with the fluid or polymer. Excitation at said first frequency causes at least two differing regions of the surface to move in phase relative to each other, and excitation at said second frequency causes the two regions to move out-of-phase relative to each other, inducing a vertical displacement in the separation area therebetween. Integrating comprises integrating the transfer function over the first mode and over the second mode. This aspect of the invention allows calculating two of the fluid or polymer properties utilizing results of the integration and information relating to a third fluid or polymer property, wherein the two fluid or polymer properties and the third fluid or polymer property are selected from density, viscosity and elastic modulus. The skilled in the art will recognize that if one of the three fluid or polymer properties above is known or assumed, a single sensor operating according to the methods described above will allow calculating the other two parameters. By way of non-limiting example, the desired calculations may be derived as described for a fluid, below:

U.S. patent application Ser. No. 12/036,125 discloses methods for computing several fluid parameters, if others are known. An important principle of the '125 application is that differing anharmonic modes of a multi-mode quasi-shear resonator (MMQSR) have comparable shear tangential motion in a plurality of regions of the sensing surface but with differing relative phases. The differing anharmonic modes have differing degrees of vertical (compressional) motion that result from the conservation of angular momentum at the interfaces between regions of differing phase of shear tangential motion. This behavior results in a relationship between the change in the motional resistances of at least two of the plurality of modes and the material properties that may be related by the matrix equation

ΔRs=c₁₁\sqrt{ρη}+c₁₂\sqrt{ρ c̅}=c₁₁X₁+c₁₂X₂

ΔRa=c₂₁\sqrt{ρη}+c₂₂\sqrt{ρ c̅}=c₂₁X₁+c₂₂X₂

for an assumed symmetric and antisymmetric mode. The '125 application makes the approximation that C₁₁=C₂₁=Kₒ; C₁₂=K₁; and C₂₂=K₂. The skilled in the art will recognize that the ideal fluid viscosity, η, can be replaced by the viscoelastic term, η/(1+ωτ) and that the discussion of the '125 application can be expanded to allow C₁₁≠C₂₁. The above assumptions are contained herein for continuity and simplicity and should not be considered as limiting.

In the '125 application, the motional resistance is simply assumed measurable. In the present invention, an integral of a transfer function is related to a fluid or polymer property. Since there exists a mathematical and physical relationship between motional resistance and the fluid properties from the '125 application and since there is shown a mathematical correlation between the integrals and said fluid or polymer properties herein, there exists a relationship between the integral of the transfer function and the motional resistance. Such relationship may be modeled, computed or measured. However once the motional resistances are determined, the elastic modulus may be calculated according to the formula,

$${\overline{c}}_{F} = \frac{1}{{ρ}_{F}} {( \frac{Δ {R}_{A} - Δ {R}_{S}}{( {K}_{2} - {K}_{1} )} )}^{2} .$$

In this equation, ΔR_{A} is the change in the motional resistance of the antisymmetric resonant mode and ΔR_{S} is the change in the motional resistance of the symmetric resonant mode.

The viscosity may be calculated according to the formula,

$${η}_{F} = \frac{1}{{ρ}_{F}} {( \frac{Δ {R}_{S} - {K}_{1} \sqrt{{\overline{c}}_{F} {ρ}_{F}}}{{K}_{o}} )}^{2} .$$

The density may be calculated according to one of the formulae,

$${ρ}_{F} = \frac{1}{{\overline{c}}_{F}} {( \frac{Δ {R}_{A} - Δ {R}_{S}}{( {K}_{2} - {K}_{1} )} )}^{2} or {ρ}_{F} = \frac{1}{{η}_{F}} {( \frac{Δ {R}_{S} - {K}_{1} \sqrt{{\overline{c}}_{F} {ρ}_{F}}}{{K}_{o}} )}^{2} .$$

The skilled in the art will recognize that the method of integrating transfer functions may also be employed to arrive at the fluid properties without the intermediate step of converting to motional resistance and without the exact mathematics of the '125 application. Noting that the integrals are in some manner representative of the resistances, it is also possible to correlate a function of one integral to the viscosity and the difference of functions of the integrals to the density. Better results are obtained in a more preferable method whereby the first integral is corrected using a term related to the density.

Further embodiments of the invention may comprise controlling the level of the input power for controlling the shear rate at which the measurement of fluid parameters is taken. Furthermore, if a plurality of measurements is taken at a different input power level, the fluid characterization may be constructed showing the measured fluid parameters over a plurality of shear rates at which the measurement is taken.

In a preferred embodiment the integration occurs utilizing a sigma-delta analog to digital converter. However the skilled in the art will recognize that the integration and the rest of the calculations and measurements may occur in varying combinations of hardware and/or software. Finite summation approximations to integrals are also considered to provide useful data and the scope of the invention may extend thereto.

In yet another aspect of the present invention, there is provided a method of measuring fluid properties comprising the steps of providing an acoustic wave device AWD, and feeding said AWD a noise signal. Obtaining an output signal from the AWD the output signal determining on a preselected transfer function of the AWD, and the magnitude of the noise signal, and integrating the transfer function over time, allows deriving the fluid properties. Similar to the aspects claimed above one may utilize a wide selection of hardware and/or hardware to perform measurements and integration of the results of transfer function.

In yet another aspect of the invention, there is provided an apparatus for measuring fluid or polymer, properties comprising an input signal generator having an output, an Acoustic Wave Device (AWD) having an input coupled to the output of the signal generator. The AWD having at least one surface in contact with the fluid or polymer to be measured, and further having an output coupled to an integrator, wherein the integrator is constructed to integrate the output of said AWD. In one embodiment, the signal generator comprises a noise source. Preferably, in such an embodiment, the integrator is constructed to integrate said AWD output over time. In another embodiment the signal generator is constructed to output a plurality of frequencies, and the integrator is constructed to integrate said AWD output over a predetermined frequency range. In yet another optional embodiment, the integrator is further constructed to take a plurality of integrals over subsets of the frequency range of the signal generator.

### SHORT DESCRIPTION OF DRAWINGS

The summary above and the following detailed description will be better understood in view of the enclosed drawings which depict details of preferred embodiments. It should however be noted that the invention is not limited to the precise arrangement shown in the drawings and that the drawings are provided merely as examples.

FIG. 1 depicts a block diagram of known instrumentation configuration of an AWD.

FIG. 2 depicts an equivalent circuit of a multi-resonant AWD.

FIG. 3 depicts a simplified block diagram of the hardware arrangement in accordance with an embodiment of the present invention.

FIG. 4 depicts a graph of an ideal transfer function of the AWD of FIG. 2 with the corresponding resonant frequencies, F₀, F₁, . . . , F_{N}.

FIG. 5 depicts a more detailed view of a preferred embodiment of the invention.

FIG. 6 represents a block diagram of yet another embodiment of the invention.

FIG. 7 depicts a simplified frequency response of a typical monolithic crystal filter (MCF).

FIG. 8 depicts yet another embodiment of the invention, which offers the advantage of obtaining unique information from the two resonant modes.

FIG. 9 depicts the waveform of energy transfer function as measured at the output of the mixer 840 depicted in FIG. 8.

FIG. 10a is a plot of observed frequency dependence of the voltage transfer ratio, H₂₁, of a typical MCF with viscous fluid loading of varying levels of viscosity.

FIG. 10b shows a spurious anharmonic mode 1010 between modes 0 and 1 in the unloaded sensor and a third resonance 1015 for various acoustic viscosity values.

FIG. 11 is an example plot of the integral of the magnitude of the voltage transfer function in relation to the logarithm of the acoustic viscosity.

FIG. 12a is the real part of the voltage transfer ratio of the device in FIG. 10 with the same levels of fluid viscosity.

FIG. 12b shows zero crossings 1205 and 1210 identifying the boundaries between modes 0 and 1 and between modes 1 and 2, respectively.

FIG. 13 depicts the absolute values of the integrals over the 180° mode and the 0° mode of the real part of the voltage transfer function in relation to the logarithm of the acoustic viscosity.

FIG. 14 depicts the difference of the absolute values of the integrals over the 180° mode and the 0° mode of the real part of the voltage transfer function in relation to the density of the fluid.

FIG. 15 illustrates a preferred embodiment of the circuit of FIG. 8 in which a voltage 810 is applied and measured using op-amps 1535 and 1540. The short circuit current of the AWD is measured by inverting op-amp 1530. This arrangement accurately measures the real and imaginary components of the transfer admittance.

FIG. 16 illustrates an embodiment of the circuit of FIG. 8 in which a current 1610 is applied and measured using op-amps 1535 and 1540. The open circuit voltage of the AWD is measured by non-inverting op-amp 1630. This arrangement accurately measures the real and imaginary components of the transfer impedance.

### DETAILED DESCRIPTION

The invention will be described as it relates to the specific case of measuring a transfer function having an integral that can be readily correlated to the motional resistance response to viscosity using a shear mode AWD; however it will be readily apparent that the approach can be applied to other resonant structures and measurands having amplitude or attenuation based sensor response.

As stated above, the present invention seeks to obtain a measure of the insertion loss to represent the motional resistance change of an acoustic wave device without necessitating detailed knowledge of the resonant frequency in which this device operates at any instant.

In order to overcome the errors associated with lack of exact alignment between the signal source frequency and the sensor resonance frequency, and in order to simplify instrumentation complexity, the present invention utilizes integration of a transmission function of the device. It has long been observed that the magnitude of voltage transfer efficiency of an AWD changes with damping of the device perturbations. As the damping increases, the transfer efficiency decreases. The present invention exploits the recent observation that, for many AWD types and configurations, as damping increases the integral of the transmission function decreases monotonically and, in certain cases, logarithmically. The principle that the transmission function integral has some predictable relationship with damping offers the use of simple and relatively inexpensive instrumentation of the AWD. The existence of a logarithmic relationship offers wide dynamic range with error proportional to value rather than a limited measurement range with error proportional to full scale.

Various manners of providing and measuring the excitation signal are a matter of technical choice. By way of example, applying voltages from a low source impedance and measuring open circuit voltage outputs predetermines a voltage gain transfer function, while measuring short circuit current predetermines transfer admittance (or conductance).

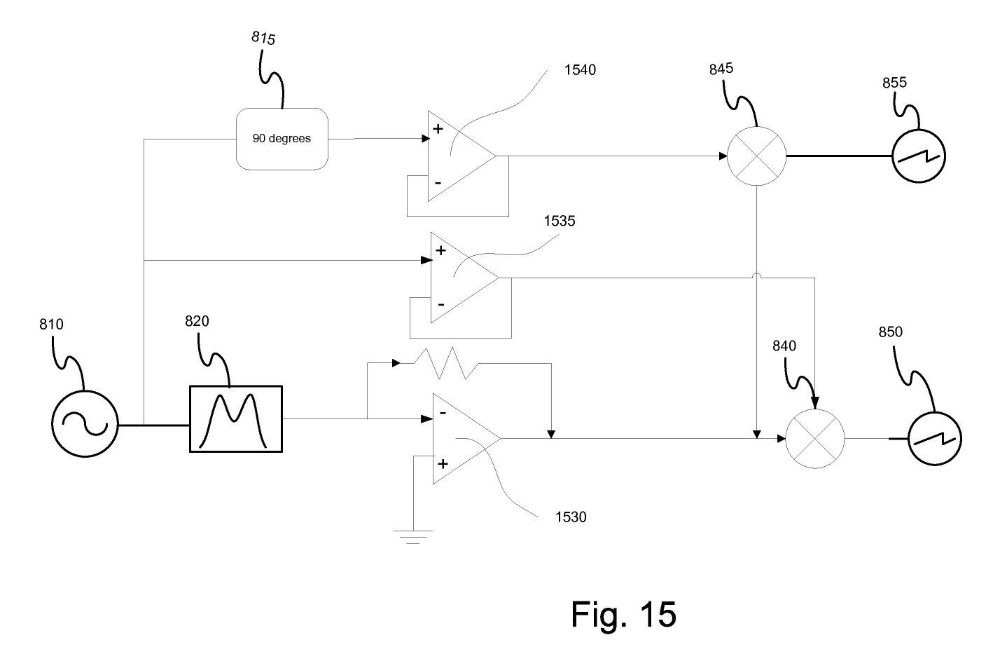

The use of voltage transfer functions in the following examples stems from the ready use of diode detector circuits as root mean square (RMS) linear detectors at signal levels above about 50 mV RMS. In many cases the device could be better measured by applying a voltage signal and measuring the short circuit output current to determine the transfer admittance, y₂₁. FIG. 15 presents such a circuit where-in the AWD is excited by voltage, Vᵢₙ, and inverting amplifier 1530 converts the short-circuit current, −Y₂₁Vᵢₙ, into an output voltage, Y₂₁R_{L}Vᵢₙ.

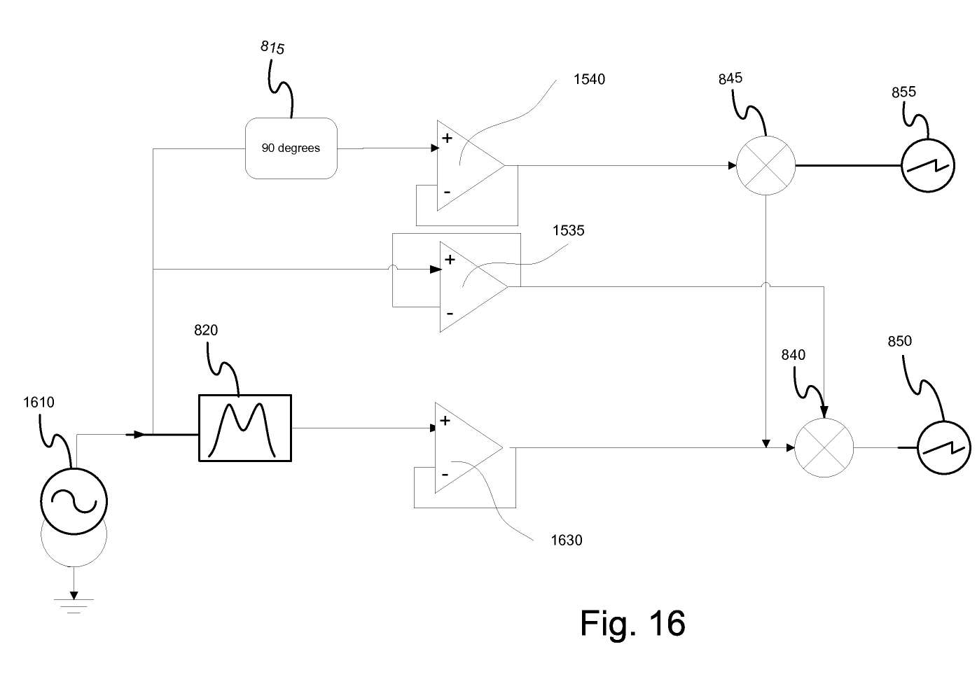

Other devices might be best instrumented with high impedance sources and loads, applying a current and measuring the output voltage to determine the transfer impedance, z₂₁. FIG. 16 presents such a circuit where-in the AWD is excited by current Iᵢₙ, and the non-inverting amplifier 1630 buffers the open circuit voltage, Vₒᵤₜ=Z₂₁Iᵢₙ.

At high frequencies scattering parameters are the preferred instrumentation and S₂₁ might be used as might the power transfer, |S₂₁|². Other transfer functions are known including current gain, hybrid parameters, and the like. Since all of the transfer functions describe transmission through the AWD, they are all mathematically related to one another as well as to the motional resistances which are to be determined.

Numerous applications require measurement of material characteristics in harsh environment, such as extreme pressure and/or temperature, corrosive areas, and the like. In the prior art the designer of an AWD sensor had to compromise between placing the circuitry in close proximity to the AWD to increase precision, or placing the circuitry remotely and suffering the effects of increased noise and cabling error. One of the notable advantages of the invention stemming from the transfer function integration of the present invention is reduced noise sensitivity. With proper selection of signal bandwidth, as the signal is integrated over time and frequency range, the effects of noise are mitigated. This advantageously allows for placement of the support circuitry remotely to the AWD with minimal, if any, effect on accuracy. Placing the AWD support circuitry remotely allows better control of the environment in which it operates, thus simplifying considerations such as temperature sensitivity corrosiveness, and the like.

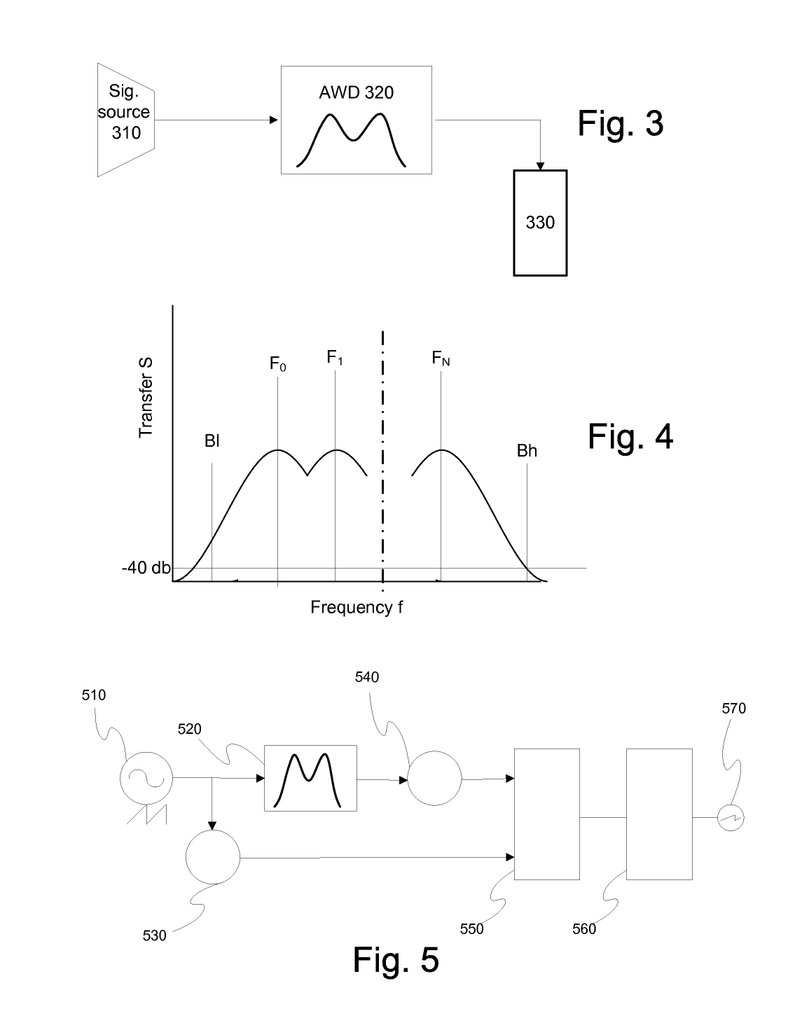

A high level block diagram of a simple embodiment of the invention is shown in FIG. 3. An AWD 320 acting as a sensor is coupled to a ‘signal source’ circuit 310. A signal measurement device 330 capable of integrating the signal current, voltage, or power transmitted through the AWD, is coupled to the sensor output.

The signal source is capable of providing signals at a plurality of frequencies ranging over a bandwidth that at least includes the passband of the AWD, and preferably extending beyond it. By way of example, the signal source may be a noise source, a spread-spectrum oscillator, a VCO, a wave form synthesizer, or any other convenient circuit that is capable of generating signal independent of the AWD. In some embodiments even a noise source may act as an appropriate signal source for the purposes of the present invention. The plurality of frequencies may be present simultaneously, using techniques such as band-limited noise or spread spectrum signaling, or the frequency may be swept, stepped, changed, or otherwise modified to sequentially apply the desired frequencies in an advantageous sequence.

The signal measurement device 330 may be implemented in many different ways, but its function is to measure the signal at the output of the AWD as an indication of the appropriate signal transfer function of the AWD and to integrate the signal current, voltage, power or associated transfer function over a predetermined subset of the frequencies. The transfer function represents the correlation between an output parameter and an input parameter. The nature or type of transfer function is determined by the nature or type of the input and output signals and the value of the transfer function is determined by measurement of the specific values. The transfer function may describe the transfer of any desired parameter pair comprising an input and an output signal, such as transfer impedance (current in, voltage out), transfer admittance (voltage in, current out), voltage transfer function, current transfer function, or power transfer function, by way of example, and may represent the magnitude, the real part, or the imaginary part of the transfer function. While each such parameter would require different scaling factors, signal sources, and/or instrumentation, the integration result will show a clear correlation between the damping and the integral of any suitably selected transfer function, since the various transfer functions are interrelated. It is possible to determine the value of the pre-selected transfer function measuring only the output signal provided that the input signal is sufficiently well behaved and well-known.

In many common applications, the transfer measurement device is implemented as a digital signal processor (DSP) but as explained below, even a simple capacitor may act to integrate the signal while a simple diode may be utilized to detect the power. Switches to start, stop, hold and clear the integration allow even this simple system to integrate a power over a frequency span, as specified herein. The skilled in the art will recognize that the specific construction of the transfer function measurement device is a matter of technical choice and extends beyond the few examples provided herein by way of non-limiting example.

AWD 320 may be any convenient acoustic wave device as selected to fit the requirements of the task at hand. For the illustrative case of measuring viscosity and density of a liquid, a multi-mode quasi-shear resonator (MMQSR) such as the MCF represents at least one preferred embodiment. Polymer film viscoelastic losses and the like may also be measured using the integral of a transfer function, and the implementation of such equivalent variations will be clear to the skilled in the art in view of the disclosure provided herein.

FIG. 4 depicts a graph of an ideal transfer function of the AWD modeled by the circuit of FIG. 2. If the AWD of FIG. 2 were placed in the system of FIG. 3, when the frequency ‘f’ of ‘signal source’ 310 is ‘swept’, i.e. changed over time and predetermined range, this would also be the signal expected at the signal measuring device 330. It was discovered that integration of the signal transfer function over the sweep would result in a single number representative of the overall signal transfer efficiency. This efficiency is embodied for each acoustic mode by the corresponding motional resistance, Rₘ. F_{1 . . . n} represent the resonant frequencies of the AWD. By proper setting of the integration limits, the effects of noise signals are minimized; however the limits must be properly selected such that residual signal outside said limits may readily be ignored while all relevant values are captured. An integral over all of the modes results in an efficiency related to the aggregate effect of the motional resistances.

As known, the AWD resonant frequency changes with mass loading, elastic stiffening of the interface, flexure, stress, pressure, electrical boundary conditions, temperature, and the like. In addition to its direct effect on efficiency, damping has a secondary effect on frequency that is related to the mass of the fluid or polymer causing the damping. By proper selection the lower band limit, Bl, and higher band limit, Bh, of the input frequency integration range, the effects of such changes, as well as that of noise, are mitigated. Preferably the bandwidth limits are selected to encompass the bandwidth of the AWD under all operating conditions to a trivial level of transmission efficiency, e.g. encompassing at least the 40 dB bandwidth over temperature and manufacturing variations. Byway of example, −40 dB is 1/10,000^{th} of perfect power transfer (1% of the voltage transfer) and may typically be ignored even over reasonably wide integration windows.

For systems wherein the AWD will experience a high degree of damping it may be desirable to select an integration range with even lower initial limits. For example, an MCF on langasite material at 5.3 MHz is seen to have a meaningful resonance in a range of liquid viscosities incurring insertion losses from <3 dB to >40 dB. At 40 dB insertion loss it would be advantageous that the level initially considered to be trivial still be small compared to the lowest meaningful measurement. An ultimate rejection of 60 dB might be chosen for the integration limits.

Since resonant frequencies also vary with several unrelated parameters and AWD's further have initial manufacturing variations, the band limits are preferably chosen to encompass the span of meaningful values over the range of operating conditions. However selection of overly wide frequency bandwidth will increase the effects of even such small levels of noise. Thus the frequency bandwidth is preferably set sufficiently close to the AWD bandwidth so as to reduce the effects of noise.

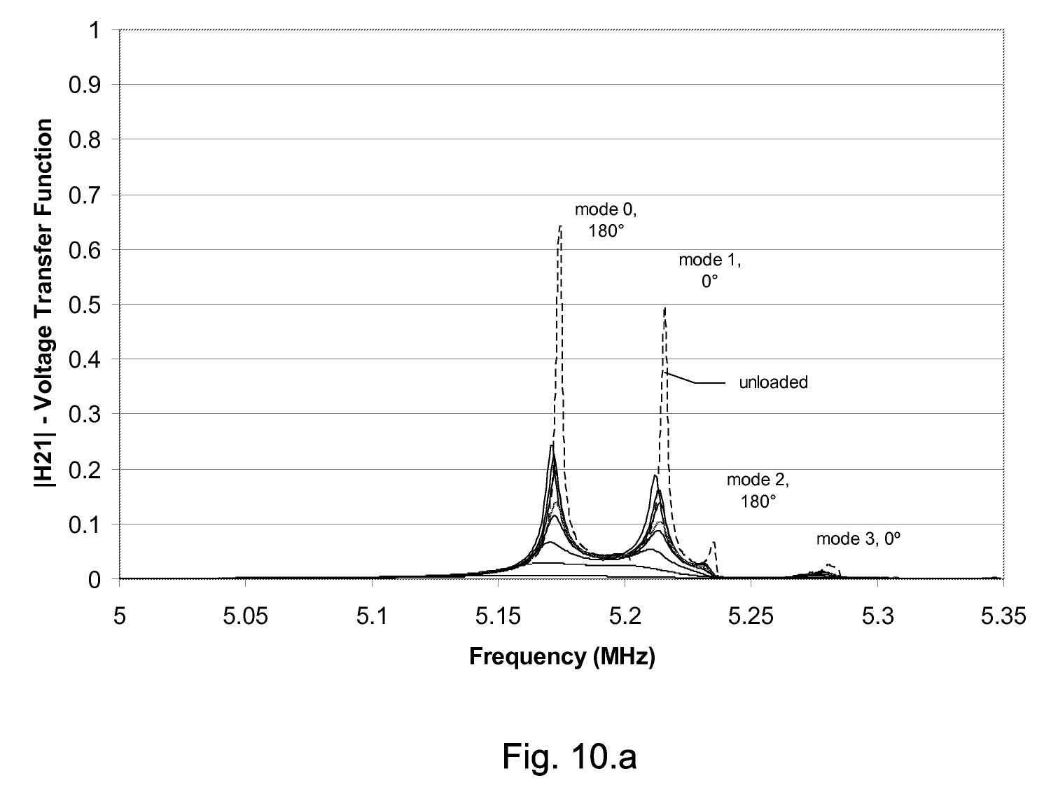

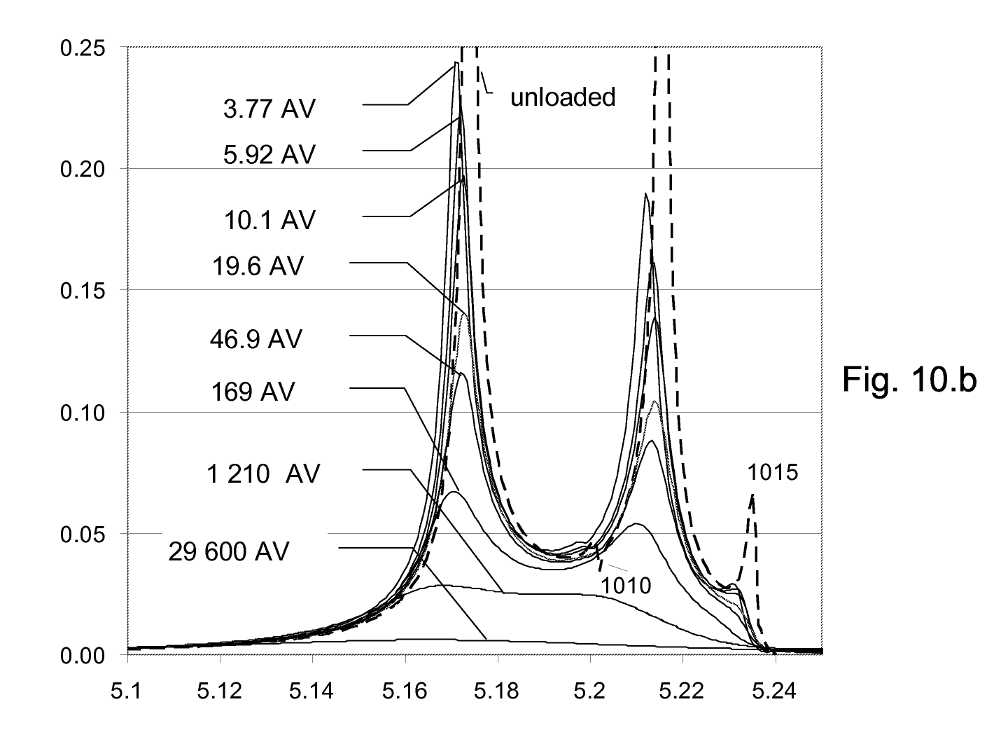

It was discovered that the integral of the area under the curve reflects changes in the fluid characteristics when the fluid is in sufficient contact with the AWD to cause damping. These effects are known to be reasonably well correlated for viscoelastic effects due to rubbery polymers that are used in amplitude-based AWD sensors, and due to the close similarities of the underlying mathematics, the skilled in the art will notice that the invention extends thereto. Most specifically when done over a properly selected frequency bandwidth, such integration was seen to be well related to some viscoelastic parameters of the liquid under measurement, the most common of which are the viscosity, the compressional elastic modulus, and the density of the fluid. The linear magnitude of the voltage transfer function (voltage gain), H₂₁, as seen in FIG. 10a was measured. Measurements were taken as the scattering parameter, S₂₁, in a 50Ω system. Due to the symmetry of the device, the scattering parameter and the forward voltage gain transfer functions are numerically equivalent. The data shows two clear peaks corresponding to mode 0 and mode 1 with a third peak corresponding to mode 2 and an ill-defined fourth peak for mode 3 (not labeled; 5.27 MHz). FIG. 10b shows a spurious anharmonic mode 1010 between modes 0 and 1 in the unloaded sensor that disappears under even small loading conditions. Mode 2 1015 is seen to decay more rapidly than mode 1 and mode 1 more rapidly than mode 0 in accordance with the '125 patent application.

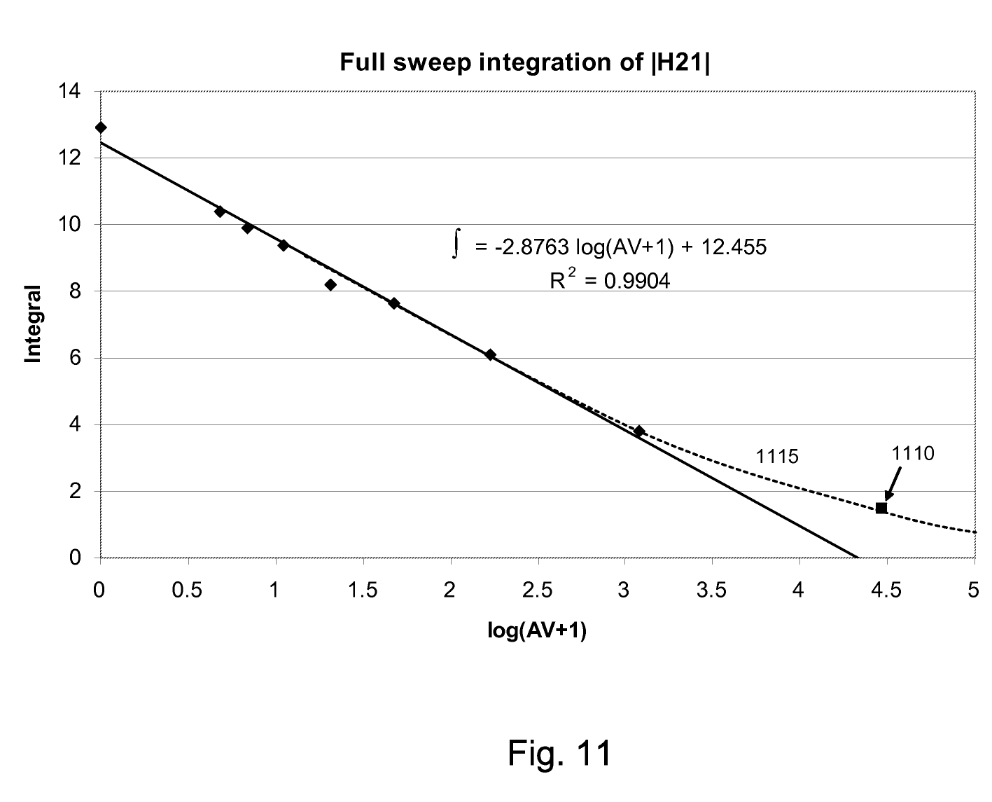

The integral of the transfer function was observed to have a logarithmic correlation such that the integrated linear magnitude was a constant minus a term proportional to the log of the viscosity-density product as seen in FIG. 11. Similar correlations could be obtained to viscosity, or kinematic viscosity (viscosity/density ratio). Non-fluid materials, such as polymers and the like, that respond to the environment through a change in damping of a resonance will enjoy similar correlations to material properties that induce the effect.

The role of background noise is seen at point 1110 corresponding to a viscosity-density product of 22,000 AV (mPa*g/cm³) as is the deviation of the curve fit from logarithmic at high viscosity as illustrated by dotted line 1115.

FIG. 5 depicts a block diagram of one embodiment of the invention. The frequency of signal source 510 is swept over a range of frequencies about the AWD 520 resonant frequency or frequencies as described above. Two signal detectors are coupled to the circuit—one 530 measures the signal inputted into the AWD and the other 540 measures the signal at the output of the AWD. The measurements might be current, voltage, power, or a hybrid parameter such as the square root of the power in a forward or reverse wave as in scattering parameters. Different measurements might be used for the input and the output signals. The outputs of the signal detectors 530 and 540 are fed into a processor 550. The processor subtracts the logarithmic signals (or divides the linear signals) and outputs a signal proportional to the instantaneous ratio of the signals, determining the value of a preselected transfer function for the units of measure of input and output signal in the design. The signal transfer function is integrated in integrator 560, which outputs a value 570 reflecting changes in damping of the AWD, such as those caused by changes in the measured material. The signal detectors 530 and 540, the adder 550, and the integrator 560 form a preferred embodiment of the transfer measurement device of FIG. 3. It will be appreciated that the functionality provided herein such as subtraction or division of signals, integration, and the like may be implemented in software as well as in hardware.

Preferably the processor and integrator functions are performed using a ratiometric analog to digital (A/D) converter, but any convenient integration method may be employed. An example of appropriate A/D converter would be a Sigma-Delta (ΣΔ) A/D converter, which takes an integrated “average” of the output detected signal using the input detected signal as the reference voltage. Modern ΣΔ-ADC incorporate digital filtering that would be unwanted in some applications; however disabling such functionality is a simple technical matter. The integration may alternately be performed by integrating the output of an A/D output of sufficiently high sample rate. In some implementations, especially where ample computing power is readily available, digital processing of the output may be performed by a microcontroller.

It is noted that other integration methods may be employed, ranging from simple resistive-capacitive integrator to any level of sophistication desired or dictated by the requirements of the task at hand. It is noted that integration over time of a response to a swept frequency stimulus is identical to integration over frequency. Summation of discrete samples is considered functionally equivalent to integration.

Similarly, the signal detectors may be implemented in any convenient way such as diode detectors, current mirrors, trans-impedance amplifiers, trans-admittance amplifiers, AGC loops, electro-optical detectors, and the like or from direct digitization and mathematical processing. The signal detectors may measure a parameter such as RMS voltage or RMS current, or may measure power, as the integration of any signal transfer function having the desired band-pass shape may be utilized for the measurement. Transfer functions having a band-stop functionality, that is having a minimum at the resonant frequency and tending to a large value as the frequency diverges from the resonance, may be inverted. Integration of the reciprocal of such a function restores the desired band-pass form. Thus the specific selection of the signal source, signal detectors and integrator used are a matter of technical choice and will be clear to the skilled in the art.

Furthermore, the input signal detector 530 may be eliminated if the signal source output is known or assumed to sufficient reproducibility and accuracy. More preferably, automatic level control may be used to control the input level to one or more predetermined and constant values such that the output signal is a direct replica of the transfer function to within a scaling factor. The processor 550 then becomes superfluous. Further, certain elements may be combined, such as the processor being combined with the integrator as may be done by way of example, with a ΣΔ A/D converter using the reference signal and the input signal respectively to divide the instantaneous signals or a differential ADC to subtract two logarithmically detected signals. An application-specific integrated circuit incorporating the detector, the converter, and additional digital processing logic will be clear to the skilled in the art.

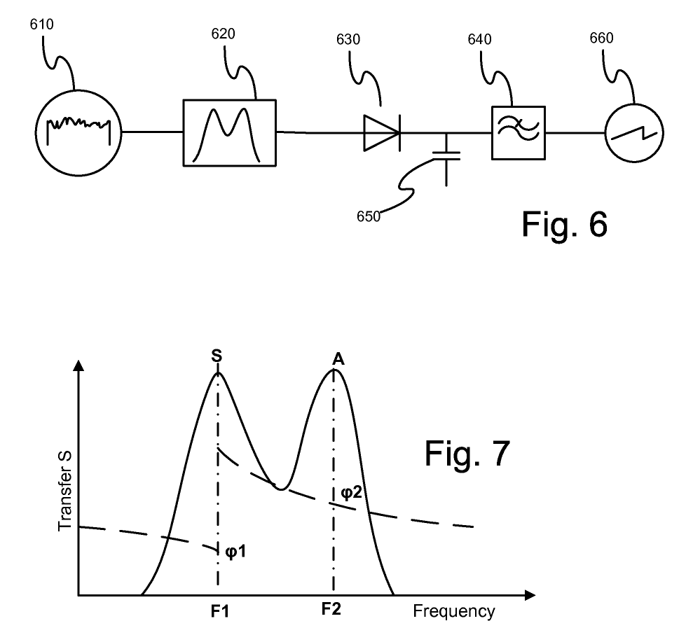

FIG. 6 represents a block diagram of an embodiment of the invention which enjoys extremely low cost and simplicity. The signal source selected for this embodiment is noise generator, preferably having a sufficiently wide spectrum to cover the bandwidth of the AWD transfer characteristic as described above and having a known, reproducible power spectral density. As an AWD is inherently a filter, when the output of noise generator 610 is coupled to AWD 620, the output is filtered in accordance with the bandpass characteristics of the AWD. Thus the AWD itself acts to form its own selection of frequencies and its frequency response forms the curve under which the integral is taken. Furthermore, since the signals are all present simultaneously, the mere act of measuring the output power of the detector 630 comprises integrating the signal. Additional integration may be required in the form of a shunt capacitor 650 to ground. The integration, whether intrinsic to the measurement system or as a step of the processing, is performed over time in this embodiment. It is noted that even a discrete measurement of a superposition of responses to a superposition of input frequencies is summation over frequency, which is considered to be integration over frequency.

It was found that an integral of the linear signal transfer ratio of the AWD may be directly correlated to the damping to which the AWD is exposed, and thus to the underlying material characteristic, as the material absorbs the energy from the AWD and is thus the cause of the damping. Thus a simple measurement circuit may be created by connecting a power detector 630 and measuring the output thereof over time. As mentioned above, a simple diode may act as a detector, but other circuits may be utilized if desired. Similarly, integrating the signal may be done by any number of methods but even a simple device such as a capacitor 650 may provide this function. The desired time characteristic may be obtained by a low pass filter 640, and the output 660 may be expressed simply as a voltage. Deployment of more elaborate devices such as A/D converters and the like will be clear to the skilled in the art in light of the teaching provided herein.

Creation of a noise generator is well within the knowledge of the skilled artisan, and a simple one may be created by amplifying a properly biased diode by way of example. A more preferred embodiment of a noise modulator utilizes a crystal or ceramic resonator operating within an oscillator and injecting it with a noise signal of a diode so as to frequency modulate the crystal output. Such an embodiment offers better limits of the frequency spectrum fed to the AWD. As described, the desired frequency range spans and somewhat exceeds the bandwidth of the AWD. In some embodiments the switching noise of a digital circuit may be of sufficient spectral content to serve as the noise source.

This embodiment allows utilizing inexpensive parts as the components require low precision. A simple signal detector such as a diode detector, low cost noise generator, and simple capacitive integration are just some examples of the simplicity and low cost options this embodiment enjoys.

Optionally, the input level to the AWD is also measured and the signals are scaled or subtracted (logarithmic) or divided (linear) to obtain the signal transmission efficiency similar to what was described for FIG. 5. The skilled in the art will also recognize the advantages of using an unloaded reference sensor in combination with a loaded sensor both driven by the noise source, and the invention seeks to encompass such embodiment as well.

As most digital processors have input and outputs, the output of such processor may be used as a signal source or as a noise source. It may be utilized as a signal source either by directly feeding the bit stream to an amplifier or by providing a Digital to Frequency (D/F) converter. If the bit stream is fed directly to the AWD, a random bit stream may be used to provide a noise generator. Thus optionally, a binary signal may be utilized as a signal source both for spread spectrum and for noise signal embodiments, directly or as baseband modulation of an appropriate oscillator.

FIG. 7 depicts a simplified frequency response of a typical dual resonant mode AWD showing both the amplitude and phase of the transfer function. The AWD has two main lobes, dubbed a ‘symmetrical’ centered about line, S, at frequency, F1, and an ‘anti-symmetric’ lobe centered about line, A, at frequency, F2. The phase of an RF signal transiting through the AWD is shifted approximately as shown by the phase lines φ1 and φ2, wherein the signal at F1 will be about 180 degrees of phase, and about 0 degrees at F2. Generally the phase at the minimum of transmission between resonances will be 90° (inductive) and the phase below and above the resonances will be −90° (capacitive). A similar pattern exists for higher numbers of resonant modes with quadrature phase at a frequency between the resonant peaks. With a plurality greater than 2 there may also exist transmission zeros between the resonances, which is immaterial to the present discussion.

The transfer function may be a scattering parameter, S₂₁, the voltage or current gain, the transfer-impedance or the transfer-admittance, among others. The figure arbitrarily depicts scattering parameter, S₂₁.

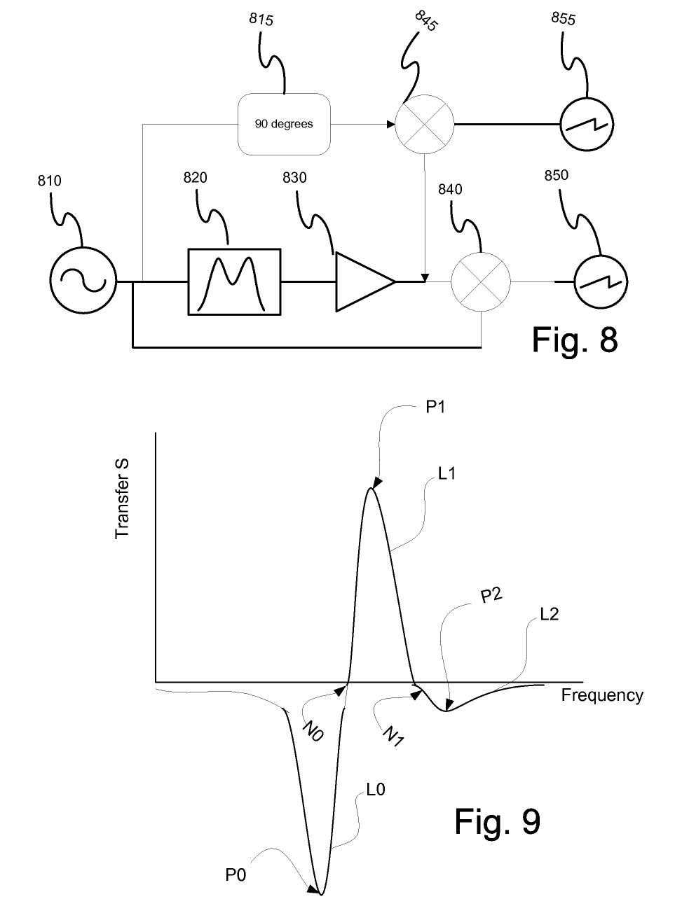

FIG. 8 depicts yet another embodiment of the invention, which offers the advantage of clearly discriminating between the two or more modes, with the resulting advantage of being able to utilize a single AWD to sense a plurality of characteristics of the fluid under measurement, such as measuring viscosity, density, and elastic modulus. Signal source 810 is a generator capable of sweeping across a given frequency range. The signal source is coupled to AWD 820 and to one input of four quadrant frequency mixer 840. The output of the AWD is coupled to a second input of the frequency mixer 840, via an optional amplifier 830. Preferably amplifier 830 should be a stable device with consistent input impedance. The use of Gilbert Cell type active mixers obviates any need for amplifier 830. The nature of the amplifier 830 and/or mixers 840 and 845 determine whether the output signal parameter is voltage, current, or power. The natures of mixer 840 and the signal generator 810 determine whether the input signal behaves as a current, voltage or power signal. There are significant advantages to employing voltages as the input signal and currents as the output signals, obtaining a transfer conductance at output 850 and a transfer susceptance at optional output 855.

As the four quadrant frequency mixer is phase sensitive, differences in phase will cause a signal with value as depicted in FIG. 9. There will likely exist a small and preferably insignificant signal at frequencies below signal lobe L0. The null points N0, N1, and so forth represent points in frequency (and in time for a swept frequency) where the input and output signals of the AWD applied to the mixer have a phase difference that is a multiple of 90 degrees and denote the boundaries between adjacent modes of the AWD. L0, L1 and L2 are lobes that reflect the real (in-phase) part of the signal transmission function of the AWD for modes 0, 1, and 2. Note that L0 is negative while L1 is positive for a typical MCF and that the spectral content far below L0 and above N1 is typically very small. In FIG. 10a, a well defined but low strength mode 2 is seen and a less-defined mode 3 is also observed. Peak detection of the signal can obtain the frequency information for F0, F1, and F2 corresponding to P0, P1, and P2 which may be utilized to derive information about the other resonances of the AWD relating to selected measured parameters (e.g. mass loading in a fluid trap or rubbery polymer, etc.). Null detection is considered more reliable for identifying critical frequencies since the peaks tend to be very flat and broad at high levels of damping.

It was found that the integral of the transfer conductance, voltage gain, or other related transfer function under each lobe is related to the motional resistance of the AWD for that resonant mode. Thus integrating the area under the curve of L0 and under the curve of L1 provides two scalar values which vary so as to reflect the changes of the behavior of specific modes of the AWD as a result of changes in AWD loading which is result of changes the characteristic of the measured material.

In keeping with the objective of allowing low sensitivity to the limits of integration, one preferred embodiment integrates the transfer parameter from well below the mode 0 lobe L0 until the zero crossing, and between zero crossings. Yet another embodiment utilizes integration of only negative values into one integral and only positive values into another integral. This approach naturally partitions L0+L2 into one integral and L1+L3 into another, for instance. Since L2 and L3 are small, the error can be expected to be negligible in some applications. These approaches and others will be clear to one skilled in the art as solutions to the selection of band limits of integration.

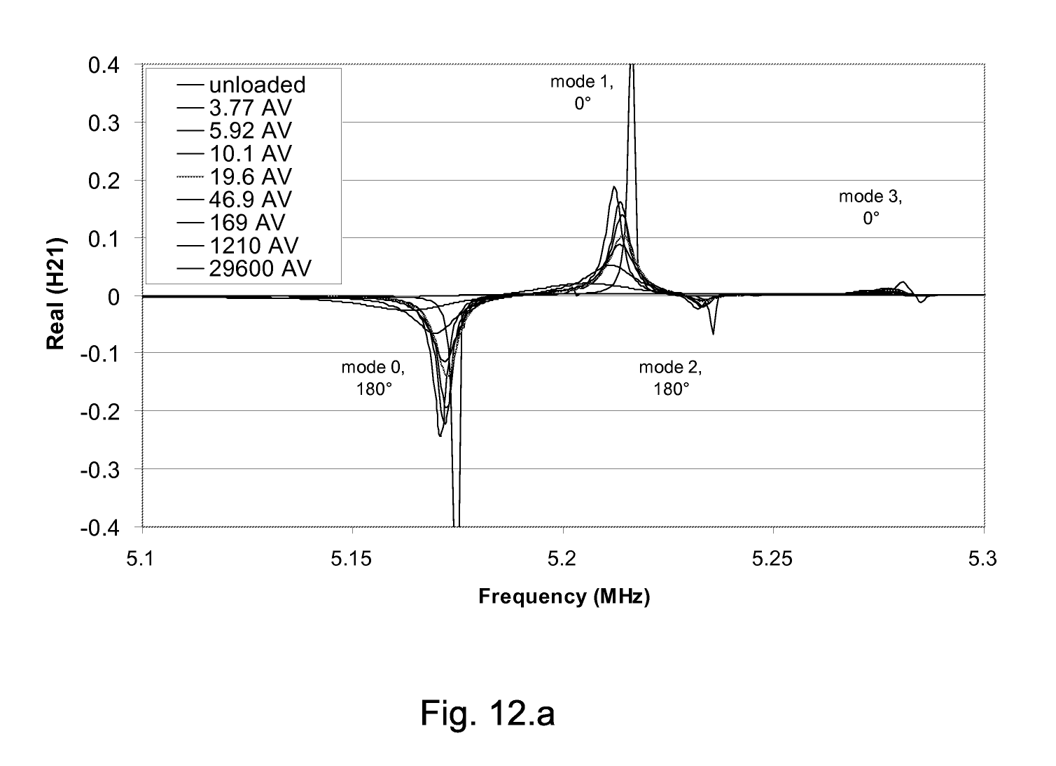

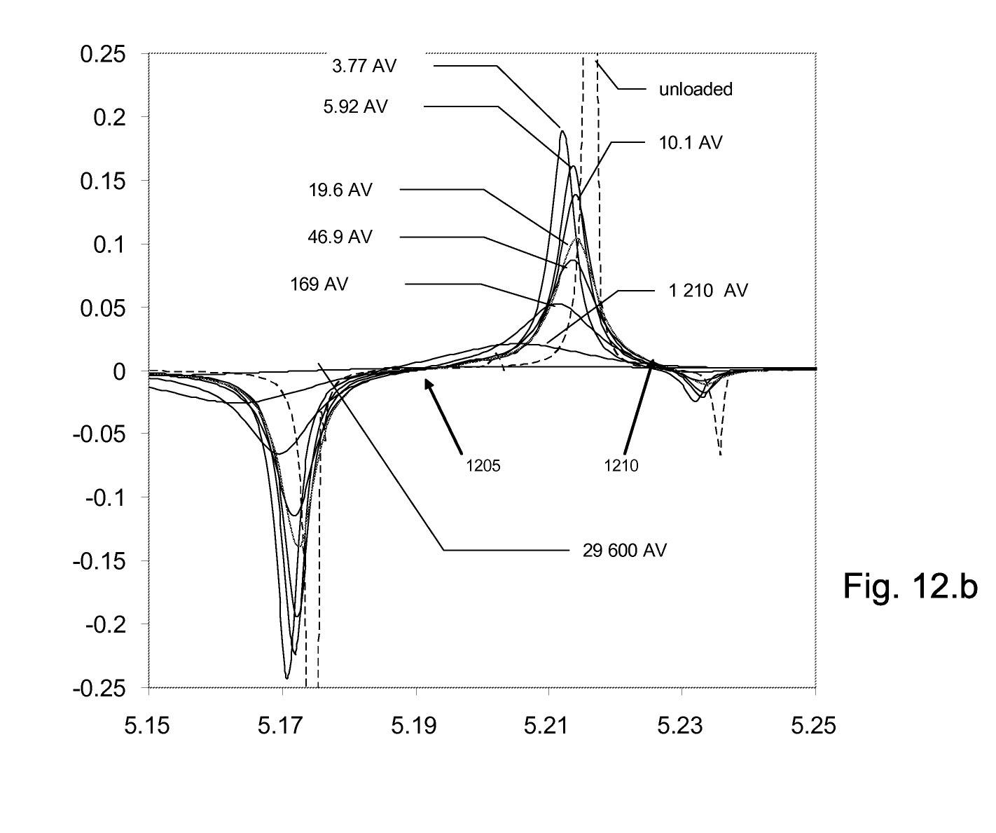

FIG. 12a shows the real part of the voltage transfer ratio for the device whose voltage magnitude transfer results are shown in FIG. 10. A preferred embodiment of the invention examines only the real part, which results in substantially clearer resonances and isolates resonant modes from one another. The detailed view of FIG. 12b shows nodes N0 1205 and N1 1210 are clearly identified. The resonance lobes L2 of mode 2 and L3 of mode 3 become well defined even with fluid loading.

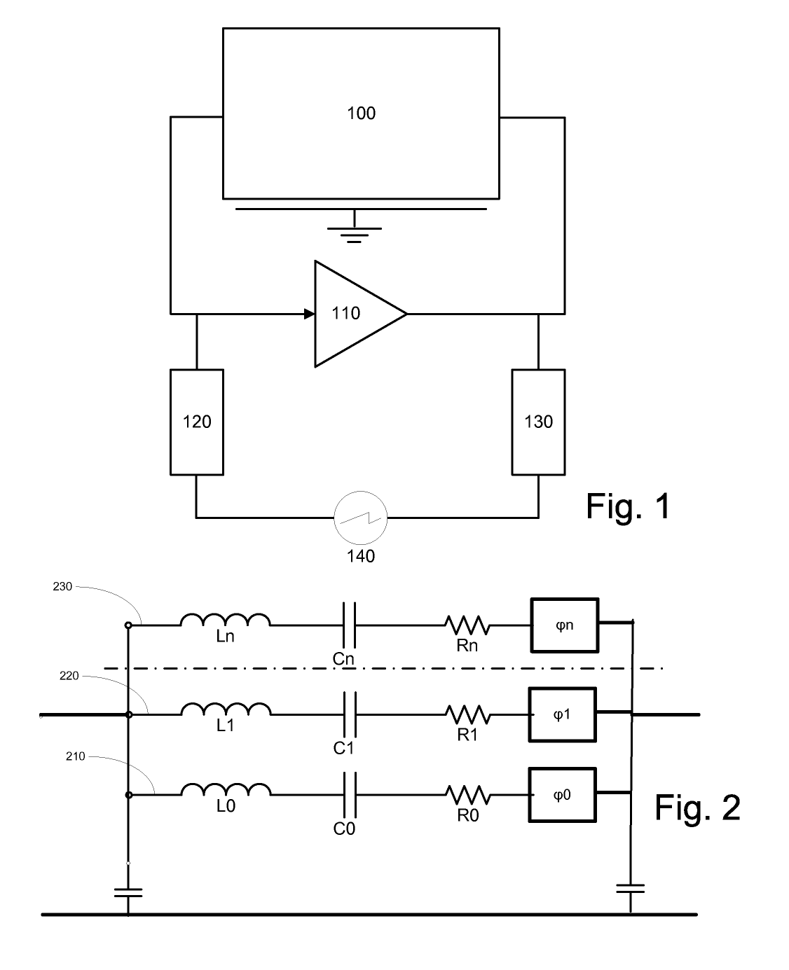

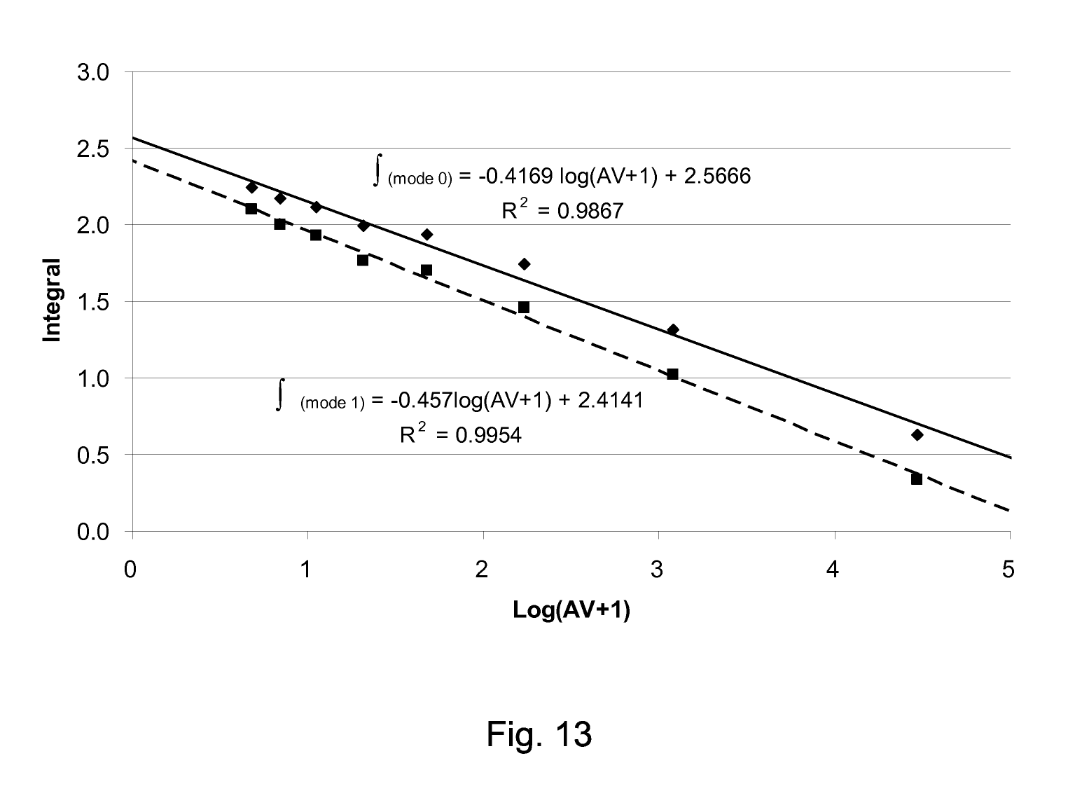

FIG. 13 shows the correlation of the integrals of L0 and L1 to the logarithm of viscosity-density product. Whereas small signals and broad lobes hampered the correlation of FIG. 11 to very high viscosity, correlation now remains strong well past 20,000 AV. The same device in an oscillator has >5% deviation from its calibration curve at only 500 AV in a typical oscillator circuit of FIG. 1 and was instrumentable to ˜2000 AV in FIG. 11. The 40-fold improvement in measurement range over an oscillator and 10-fold improvement over the magnitude integral allows substantial advantages in many practical applications.

The skilled in the art will recognize that the four quadrant mixer is but an example and similar results may be obtained by a four quadrant multiplier and the like or by direct digitization and digital signal processing. Thus the term four quadrant mixer should be construed as relating to all common circuits for combining at least two signals while taking into account phase relationship. The most preferred mixer is a sampling mixer in which the output is independent of the amplitude of a “switching” input and has a baseband output voltage proportional to the second input amplitude and the cosine of the phase between the signals.

The integration of the area under lobes L0 and L1, respectively, offers data representative of the motional resistances of the AWD within the specific equivalent circuit branches representing each of the resonant modes. The phase difference of the modes is captured in the sign of the integral, allowing ready discrimination of the two modes, while the magnitude captures the motional equivalent series resistance. Furthermore, the null points N0, N1, N2 . . . represent intermediate (quadrature) points between the various mode resonant frequencies, thus allowing measurement of frequency shifts. To a reasonable approximation, frequency N0 represents the nominal center frequency of the sensor. Alternately, peak detection within a lobe offers a good approximation of the series resonant frequency of the mode. As can be seen, the integration of the signal over frequency, and detection of the null and/or peak frequencies, provides data that would otherwise require other and more complex circuitry near the AWD.

A simple analog null detector and/or digital signal processor may be utilized to identify null points N0, N1, and N2. Peak detection may be used to identify the resonant frequencies, P0, P1 and P2. Additional null and resonant frequencies may exist in multi-mode resonators. As those points are used to control the frequencies fed to the AWD, the integration under the curve of each lobe becomes a simple summation process which may be implemented digitally such as by a processor or ASIC, or by other dedicated hardware, or in analog signal processing circuitry using an integrator.

Using simple diode circuits to only sum negative signals or to only sum positive signals provides partitioning of mode 0 and mode 1 in a typical 2 pole MCF.

Mixed signal processing using a ΔΣ analog to digital converter is also contemplated, as well as other integration methods that will be clear to the skilled in the art.

FIG. 13 shows the correlation between density and the difference of the integrals. As predicted by the theoretical portion of the '125 patent application, additional losses due to compressional wave radiation into the fluid are more significant for the anti-symmetric mode than for the symmetric mode and are proportional to density.

In U.S. Pat. No. 7,552,619 described above, the common mode frequency shift of the two resonant frequencies is related to mass loading due to the entrapped fluid for a device with a textured surface, while the energy absorbed by the fluid at one of the resonant frequencies is related to the viscosity-density product of the fluid. With the embodiment of the present invention described in FIG. 8, the frequency shift may be determined by peak detection at any desired lobe or by detecting null, N0, while the integral under the curve of each of the two lobes, L0 and L1, provides data proportional to the energy absorbed, which may be computationally manipulated to derive the viscosity-density product of the fluid as described in U.S. Pat. No. 7,552,619. Thus when embodied as described herein, the invention allows complete measurement of both density and viscosity in one sensor, with remote instrumentation.

Similarly, using a MMQSH resonator as described above in relation to U.S. patent application Ser. No. 12/036,125, allows measurement of any two parameters of density, viscosity and elastic modulus, when the third is known. This is done by sweeping the frequency of signal source 810 to cover at least the two modes of the MMQSH resonator, obtaining the equivalent series resistance (ESR) of the at least two modes using the method of correlating the integral of the associated at least two lobes to the ESR of the at least two modes. The ESRs are then compared to the unloaded baseline values to obtain the resistance shifts, ΔR_{S} and ΔR_{A}, (and/or ΔRₙ for the nth mode), as described in the '125 application and repeated herein. The skilled in the art will recognize that R_{S,} R_{A,} and R_{n,} relate to the ESR equivalent of the symmetric, anti-symmetric, and Nth mode frequencies respectively.

As has been stated above, the ESR is reflective of the motional resistance of FIG. 3 and is directly related to the integral of the transfer function through mathematically sound correlation. Throughout these specifications, the ESR and changes therein from US '125 application may be replaced by a function of the integral of a transfer function with no significant change to the meaning and method of the equations below. The exact functions required can be determined by one skilled in the art using ordinary methods such as analytical mathematics and graphical curve-fitting.

The difference between ΔR_{S} (symmetric resistance) and ΔR_{A} (asymmetric resistance) is related to \sqrt{c̅_{F}ρ_{F}}. In particular the insertion loss can be used to estimate the resistance at the resonance associated with j=1 before and after fluid loading, in which case ΔR_{S}, expressed as resistance change, yields

ΔR_{S}=Kₒ\sqrt{η_{F}ρ_{F}}+K₁\sqrt{c̅_{F}ρ_{F}}+ε

and the resistance change at the resonance for which j=2, in which case ΔR_{A}, expressed as resistance change, yields

ΔR_{A}=Kₒ\sqrt{η_{F}ρ_{F}}+K₂\sqrt{c̅_{F}ρ_{F}}+ε

where K₂˜4K₁, or for any other value of j,

ΔRⱼ=Kₒ\sqrt{η_{F}ρ_{F}}+Kⱼ \sqrt{c̅_{F}ρ_{F}}+ε

where Kⱼ˜j²K₁ for j=1,2,3 . . . , Kₒ is assumed to be independent of j, and ε represents the sum of other losses as an error term, assumed to be zero or implicitly extracted through the remaining disclosure. In actual devices Kₒ will likely depend slightly on mode number and preferably an average would be used analytically. The factor of 4 corresponds to the square of j=2. Taking the difference, expressed as resistance change, yields \sqrt{c̅_{F}ρ_{F}} as

$$\sqrt{{\overline{c}}_{F} {ρ}_{F}} = \frac{Δ {R}_{A} - Δ {R}_{S}}{( {K}_{2} - {K}_{1} )}$$

$$and \sqrt{{η}_{F} {ρ}_{F}} as$$

$$\sqrt{{η}_{F} {ρ}_{F}} - \frac{Δ {R}_{S} - {K}_{1} \sqrt{{\overline{c}}_{F} {ρ}_{F}}}{{K}_{o}} .$$

Solving this system of equations requires that one of the three variables be known or assumed, allowing a device and method of use thereof for the measurement of two fluid parameters. Note that in actual devices the values of j are often not exactly integers and the associated term, Kⱼ, is best obtained through sensor calibration.

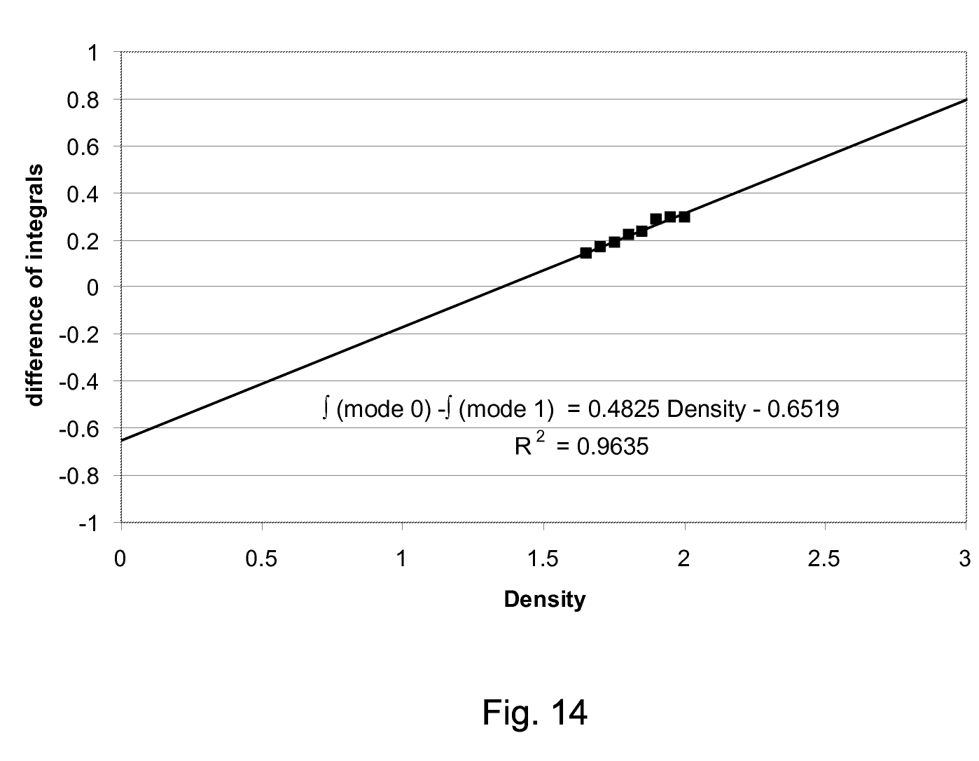

Aspects of the present invention are therefore seen as being highly applicable to the practice of the '125 US patent application's methods. The desired information may be extracted with suitable care using any of the methods herein but is especially simplified using the mixer-based, multi-integral solution of FIGS. 8, 9, 12a, 12b, 13, 14, 15 and 16, and the associated disclosure herein.

In the U.S. Pat. No. 7,434,989 patent to Solie, there exists a pair of time domain reflected signals from interconnected yet distinct AWD structures. Interferometry provides frequencies with constructive and destructive interference. An integral of the received power spectral density around a constructive interference frequency is compared to an integral of received power spectral density around a destructive interference frequency. The time domain reflected signals within finite impulse response structures combine to create constructive interference at some frequencies and destructive interference at other frequencies represented by linear superposition and destructive interference. In contrast, the present invention utilizes an infinite impulse response resonant structure to transfer selected frequencies from an input terminal to an output terminal. Furthermore, the present invention relates to energy losses inherently occurring within the AWD structures, whether practiced in a single AWD or over an aggregate or array. The U.S. Pat. No. 7,434,989 patent cannot elucidate these motional circuit parameters since resonant structures are inherently narrow bandwidth signals whereas the interferometry principle is a broadband phenomenon. Another limitation of the '989 patent resulting from the broad and repetitive interference pattern in the frequency domain is that the term being integrated does not tend to zero away from the frequencies of interest. Whereas the present invention allows loose limits on the integration frequency range, the '989 patent requires careful control of limits to correspond to peaks and nulls of an interference pattern.

Combining the present invention with both U.S. Pat. No. 7,552,619 and the '125 application allows all three properties of the fluid to be measured in a single device with low instrumentation or computational burden. Providing the fluid traps of U.S. Pat. No. 7,552,619 provides a frequency shift due to trapped fluid mass that uniquely determines the density, ρ. Applying the methods of the '125 application using the methods above provides information on viscosity, η, and compressional elastic modulus, c̅_{F}, at a known density, ρ. As stated above, monitoring the frequency of node N0 will obtain the specific frequency information.

In one particularly preferred embodiment the liquid traps comprise the gaps of a serpentine resistance-temperature device (RTD), allowing temperature, density, viscosity, and elastic modulus to all be measured in the same small volume.

It is further possible to extract a quadrature replica 815 of the driving signal 810 and feed it to a second multiplier 845 and integrator 855. The signal presented to the integrator 855 would have nulls and peaks reversed and would therefore provide a peak at N2 between frequencies P1 and P2. The appropriate integral of this signal would depict reactive signal transfer (imaginary part of the transfer function) and would therefore be related to the motional inductance and capacitance of the transmission network.

It is known that the motional reactance is related to the Hilbert transform of the motional resistance. For well defined and separated resonant peaks, the real part of the transfer functions will typically be very symmetric about a lobe while the imaginary part will be typically highly antisymmetric. Integrating the imaginary part over frequency limits corresponding to selected modes obtains zero for at least some transfer functions and offer a method of validating the integral limits for the real part; however they do not offer a good measure of the fluid properties.

The foregoing examples focus on fluid measurement; however as shown above, the physics and mathematics are equally applicable to rubbery polymers below their glass temperature. The examples rely heavily on the MCF structure; however the skilled in the art will recognize that any multi-mode resonant structure may be employed for the multi-mode embodiments described hereinabove, provided the wave displacements are compatible with the contacting material to be measured.

It will be appreciated that the invention is not limited to what has been described hereinabove merely by way of example. While there have been described what are at present considered to be the preferred embodiments of this invention, it will be obvious to those skilled in the art that various other embodiments, changes, and modifications may be made therein without departing from the spirit or scope of this invention and that it is, therefore, aimed to cover all such changes and modifications as fall within the true spirit and scope of the invention, for which letters patent is applied.

What is claimed is:

1. a method of measuring the properties of a viscoelastic material comprising the steps of:
providing a resonant acoustic wave device (AWD) in contact with said viscoelastic material;
feeding said AWD an input signal at a plurality of different frequencies;
obtaining an output signal from said AWD, said output signal and said input signal determining the values of a preselected transfer function of said AWD; and
integrating said transfer function over said plurality of frequencies for deriving said properties of said viscoelastic material.

2. A method of measuring properties of a viscoelastic material as claimed in claim 1, wherein said input signal is of known input magnitude, and wherein said transfer function is numerically represented by measurement of said output signal.

3. A method of measuring properties of a viscoelastic material as claimed in claim 1, wherein said transfer function represents the ratio between the input and output signal magnitude.

4. A method of measuring properties of a viscoelastic material as claimed in claim 3, wherein said integration is performed on the real part of the ratio between the input and output signal phasors.

5. A method of measuring properties of a viscoelastic material as claimed in claim 4, wherein said AWD has a plurality of acoustic modes, and wherein a plurality of integrals are taken over selected subsections of said plurality of frequencies, said subsections corresponding to at least a portion of said plurality of acoustic modes.

6. A method of measuring properties of a viscoelastic material as claimed in claim 5, wherein said at least two of said plurality of integrals are used to derive information regarding a plurality of characteristics of said viscoelastic material.

7. A method of measuring properties of a viscoelastic material as claimed in claim 6, wherein said plurality of characteristics consists of at least two selected from a list consisting of viscosity, elastic modulus, and density of said viscoelastic material.

8. A method of measuring properties of a viscoelastic material as claimed in claim 4, wherein said input signal is measured as an applied voltage, said output signal is current output of said AWD when said AWD is short circuited, and said transfer function is the transfer conductance of said AWD.

9. A method of measuring properties of a viscoelastic material as claimed in claim 1, wherein said plurality of frequencies are fed to said AWD simultaneously.

10. A method of measuring properties of a viscoelastic material as claimed in claim 1, wherein:
said AWD is a multi-mode quasi shear horizontal AWD;
wherein said plurality of frequencies comprise at least a first plurality of frequencies and a second plurality of frequencies selected to excite a first and a second acoustic modes respectively, each of said acoustic modes causing a component of horizontal shear wave motion in said surface;
wherein excitation in said first frequency further causing said regions to move in phase relative to each other;
and wherein excitation in said second frequency causes said two regions to move out-of-phase relative to each other, inducing a vertical displacement in said separation area;
wherein said step of integrating comprises integrating said transfer function at said first mode and second mode;
calculating two of said properties of said viscoelastic material utilizing results of said integrations and information relating to a third property of said viscoelastic material, wherein said two material properties and said third material property are selected from density, viscosity and elastic modulus.

11. A method according to claim 10, wherein said elastic modulus is calculated according to the formula
$${\overline{c}}_{F} = \frac{1}{{ρ}_{F}} {( \frac{Δ {R}_{A} - Δ {R}_{S}}{( {K}_{2} - {K}_{1} )} )}^{2} .$$

12. A method according to claim 10, wherein said viscosity is calculated according to the formula
$${η}_{F} = \frac{1}{{ρ}_{F}} {( \frac{Δ {R}_{S} - {K}_{1} \sqrt{{\overline{c}}_{F} {ρ}_{F}}}{{K}_{o}} )}^{2} .$$

13. A method according to claim 10, wherein said density is calculated according to one of the formulae
$${ρ}_{F} = \frac{1}{{\overline{c}}_{F}} {( \frac{Δ {R}_{A} - Δ {R}_{S}}{( {K}_{2} - {K}_{1} )} )}^{2} or {ρ}_{F} = \frac{1}{{η}_{F}} {( \frac{Δ {R}_{S} - {K}_{1} \sqrt{{\overline{c}}_{F} {ρ}_{F}}}{{K}_{o}} )}^{2} .$$

14. A method according to claim 10, wherein the interface between said AWD and said material is textured, said material is a fluid, and said density is calculated using a shift in the resonant frequency of said AWD.

15. A method of measuring properties of a viscoelastic material as claimed in claim 1, further comprising the step of controlling the level of said input power for controlling the shear rate at which the measurement of said properties is taken.

16. A method of measuring properties of a viscoelastic material as claimed in claim 1, further comprising the steps of:
performing a plurality of measurements of at least one of said material parameters, each of said plurality of measurements being conducted at a different input power level for controlling the shear rate at which the measurement is taken; and,
characterizing said material by producing a correlation between said parameter as being measured at said input power levels and said controlled shear rates at which the plurality of measurements are taken.

17. A method of measuring material properties as claimed in claim 1, wherein said integration occurs utilizing a sigma-delta analog to digital converter.

18. A method of measuring properties of a viscoelastic material comprising the steps of:
providing an acoustic wave device AWD in contact with said viscoelastic material;
feeding said AWD a noise signal;
obtaining an output signal from said AWD said output signal and the magnitude of said noise signal determining the value of a preselected transfer function of said AWD; and
integrating said transfer function over time, for deriving said viscoelastic material properties.

19. A method of measuring properties of a viscoelastic material as claimed in claim 18, wherein said integration is performed utilizing a sigma-delta analog to digital converter.

20. A method of measuring at least one property of a viscoelastic material as claimed in claim 1, wherein said step of integrating is performed separately on the imaginary part of said transfer function.

21. An apparatus for measuring properties of a viscoelastic material comprising:
an input signal generator having an output;
an AWD in contact with said viscoelastic material having an input coupled to said output of said signal generator, and an output;
an integrator having an input coupled to said output of said AWD, said integrator constructed to integrate the transfer function relating said input signal and said output of said AWD.

22. The apparatus as claimed in claim 21, wherein said signal generator comprises a noise source.

23. The apparatus as claimed in claim 21 wherein said integrator is constructed to integrate said AWD output over time.

24. The apparatus as claimed in claim 21 wherein said signal generator is constructed to output a plurality of frequencies, and wherein said integrator is constructed to integrate said AWD output over a predetermined frequency range.

25. The apparatus as claimed in claim 24, wherein said integrator is further constructed to take a plurality of integrals over subsets of said plurality of frequencies.

26. An apparatus as claimed in claim 21 wherein said input signal is known and is used by said integrator to determine said transfer function.

27. An apparatus as claimed in claim 26 wherein said input signal is controlled to a desired, constant value, wherein said output signal is a direct representation of said transfer function and wherein said integrator integrates said output signal as a representation of said transfer function.
